(19) United States
(12) Patent Application Publication
(10) Pub. No.: US 2004/0243398 A1
(43) Pub. Date: Dec. 2, 2004

(54) Voice recording and reproducing apparatus and additional voice information recording method

(75) Inventor: Takeo Yamada, Fukaya-shi (JP)

Correspondence Address: Finnegan, Henderson, Farabow, Garrett & Dunner, L.L.P., 1300 I Street, N.W., Washington, DC, 20005-3315, US

(73) Assignee: KABUSHIKI KAISHA TOSHIBA

(21) Appl. No.: 10/803,941

(22) Filed: Mar. 19, 2004

(30) Foreign Application Priority Data
May 30, 2003 (JP) 2003-155464

(51) Int. Cl. G10L 19/00

(52) U.S. Cl. 704/201

(57) ABSTRACT

An inputted voice is recorded as a main voice into a recording medium, a voice associated with the main voice recorded into the recording medium is inputted, and then, the voice is recorded as additional voice information into the recording medium to be associated with the main voice. After a file number indicating the main voice recorded into the recording medium has been selected, the additional voice information associated with the main voice is reproduced. The contents of the main voice can be checked by the reproduced additional voice.

### CROSS-REFERENCE TO RELATED APPLICATIONS

This application is based upon and claims the benefit of priority from the prior Japanese Patent Application No. 2003-155464, filed May 30, 2003, the entire contents of which are incorporated herein by reference.

### BACKGROUND OF THE INVENTION

1. Field of the Invention

The present invention relates to a voice recording and reproducing apparatus capable of compressing and storing a voice as digital data in a recording medium, and reproducing the stored data.

2. Description of the Related Art

A voice recording and reproducing apparatus for compressing voice data recorded at one record, and recording the compressed data as a file in a recording medium such as a semiconductor memory card is well known. Further, there has been a conventional apparatus for recording a plurality of files into a recording medium, and adding a “comment” to each file, enabling easy file search. This comment is provided as additional information helpful as a title or memo which indicates the contents of recorded files. In such a conventional apparatus, comment input is performed on a one by one character basis by operating a plurality of buttons such as a keyboard having numerals, alphabets, Japanese graphic Hiragana characters, Japanese graphic Katakana characters, and signs. Therefore, although free character input is possible, such input is very complicated, and requires very hard work.

In addition, a voice recording and reproducing apparatus capable of comparatively easily making a search for a desired record portion is disclosed in Jpn. Pat. Appln. KOKAI Publication No. 2001-236097 (page 3, FIG. 3). In the apparatus disclosed in this patent document, index information is recorded in an IC memory together with a series of voice data, and the index information is specified during data reproduction, whereby reproduction of voice data is started from a data recording start position specified by the index information. Moreover, in this apparatus, in a process in which a series of voice data is recorded in an IC memory, index information is added to voice data to be recorded at a predetermined period by means of a microcomputer.

In the case of the apparatus disclosed in the above-described patent document, the contents of the recorded voice data cannot be understood from the index information. Thus, in the case where a large number of record items exist, desired voice data cannot be correctly selected.

### BRIEF SUMMARY OF THE INVENTION

A voice recording and reproducing apparatus according to one aspect of the present invention comprises: a first voice recording portion which records an input voice as a main voice into a recording medium; a second voice recording portion which inputs a voice associated with the main voice recorded into the recording medium, and records the voice as additional voice information into the recording medium to be associated with the main voice; a selector portion which selects the main voice recorded into the recording medium; an additional voice reproducing portion which reproduces the additional voice information to be associated with the main voice selected by the selector portion; and a main voice reproducing portion which reproduces the main voice selected by the selector portion.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram depicting a voice recording and reproducing apparatus according to the present invention;

FIG. 2 is a flow chart showing a main flow of an operation according to the present invention;

FIG. 3 is a flow chart showing an operation for recording a main voice;

FIG. 4 is a flow chart showing an operation for recording a voice title;

FIG. 5 is a flow chart showing an operation for reproducing the main voice;

FIG. 6 is a flow chart showing an operation for reproducing and changing the voice title; and

FIG. 7 shows a structure of one file including record data on the main voice and the voice title.

### DETAILED DESCRIPTION OF THE INVENTION

Hereinafter, embodiments of the present invention will be described in detail with reference to the accompanying drawings.

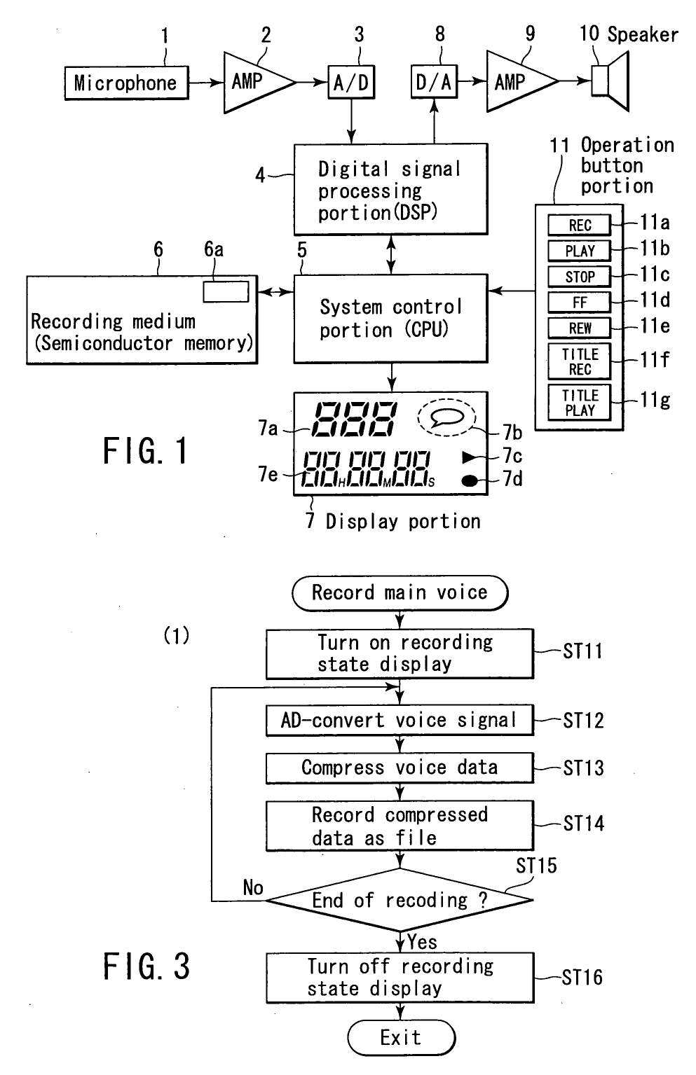

FIG. 1 is a block diagram depicting a voice recording and reproducing apparatus according to one embodiment of the present invention. An operation button portion 11 is provided as a user interface for inputting a user's instruction. This portion includes a record button 11a, a reproduction button 11b, a stop button 11c, a forward button 11d, a backward button 11e, and a title record button 11f, and further, includes a title reproduction button 11g as required. A system control portion (CPU) 5 controls each circuit block in this apparatus according to a button pressed by the user.

A microphone 1 converts an inputted voice into a voice signal, and an amplifier 2 amplifies the voice signal. An A/D converter 3 converts an analog voice signal supplied from the amplifier 2 into a digital signal. A digital signal processing portion (DSP) 4 compresses (encodes) the digital signal supplied from the A/D converter 3 under the control of the system control portion 5. The system control portion 5 records the compressed data as one file into a recording medium 6 such as a semiconductor memory.

A display portion 7 includes an LCD (liquid crystal display), for example, and includes a file number display portion 7a, a voice title mode display portion 7b, a reproducing mode display portion 7c, a record mode display portion 7d, and a recording or reproducing integral time display portion 7e.

The system control portion 5 reads out voice data recorded as a file into the recording medium 6 during voice reproduction, and decodes (decompresses) the read-out voice data by a DSP 4. The decoded voice data is converted into an analog voice signal by a D/A converter 8, the converted analog voice signal is amplified by an amplifier 9, and the amplified signal is outputted as a voice by means of a speaker 10.

Now, an operation of a voice recording and reproducing apparatus according to the present invention will be described in detail.

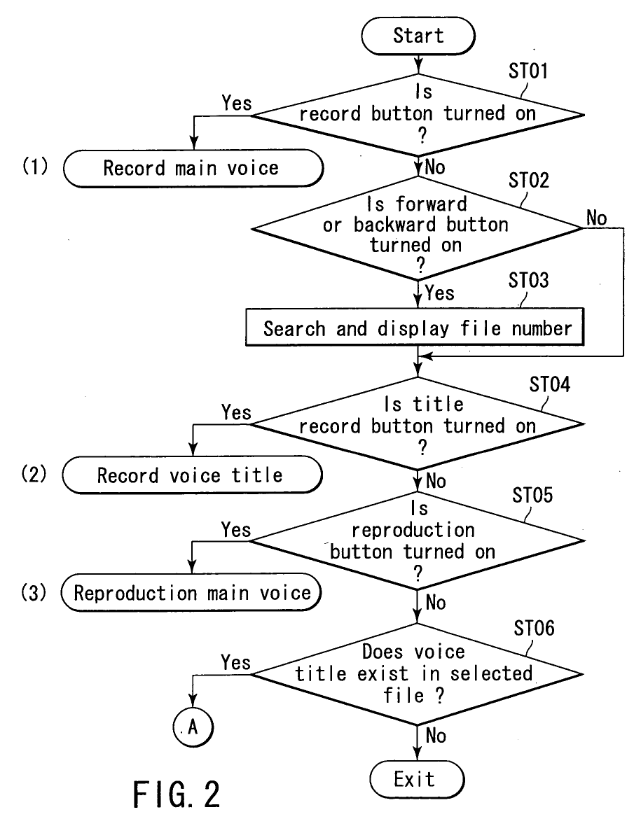

FIG. 2 is a flow chart showing a main flow of an operation according to the invention. In the following description, voice data generally recorded by the recording and reproducing apparatus is referred to as a “main voice”, and data associated with the recorded main voice and consisting of voice information recorded to explain the contents of the main voice is referred to as a “voice title”.

(1) Operation for Recording “Main Voice”

As in step ST01 of FIG. 2, the apparatus enters a record mode according to a press of the record button 11a of the operation button portion 11. The system control portion 5 records the voice inputted from the microphone as a main voice into the recording medium 6.

FIG. 3 is a flow chart showing an operation for recording a main voice. The display portion 7 displays a record state (ST11). Namely, the display portion 7 displays the record mode display portion 7d which indicates that an operation mode is a recording mode, and the recording integral time display portion 7e which indicates an elapsed time of recording. In addition, this display portion displays a number allocated to a file of record data being recorded at the recording data file number display portion 7a. At this time, as described above, the voice inputted from the microphone 1 is amplified by the amplifier 2, and the amplified voice is converted into digital signals by the A/D converter 3 (ST12). Then, the converted signals are compressed by the DSP 4 (ST13), and the compressed signals are sequentially recorded in the recording medium 6. At this time, data on a main voice recorded in the recording medium 6 is stored as one file (ST14).

When the stop button 11c of the operation button portion 11 is pressed (in the case of YES in ST15), the system control portion 5 turns OFF the display of the recording state at the display portion 7 (ST16), and ends recording.

At the start and end of recording of this main voice, the record button 11a of the operation button portion 11 can be configured in the form of a recording ON/OFF switch. That is, the above record button can be configured such that recording is started by turning ON the recording switch and recording is ended by turning OFF the recording switch.

(2) Operation for Recording “Voice Title”

A file of the recorded main voice can be searched for by pressing the forward feed button 11d or the backward feed button 11e of the operation button portion 11, as in the step ST02 of FIG. 2. That is, the system control portion 5 sequentially selects recording data files of the main voice stored in the recording medium 6 according to a press of the forward feed button 11d or backward feed button 11e, and displays the file number of the selected main voice at the file number display portion 7a of the display portion 7 (ST03)

In this state, the system control portion 5 determines whether or not the title record button 11f has been pressed as in step ST04. In the case where the determination result is affirmative (in the case of YES), a recording mode of the voice title associated with the selected recording data file is established.

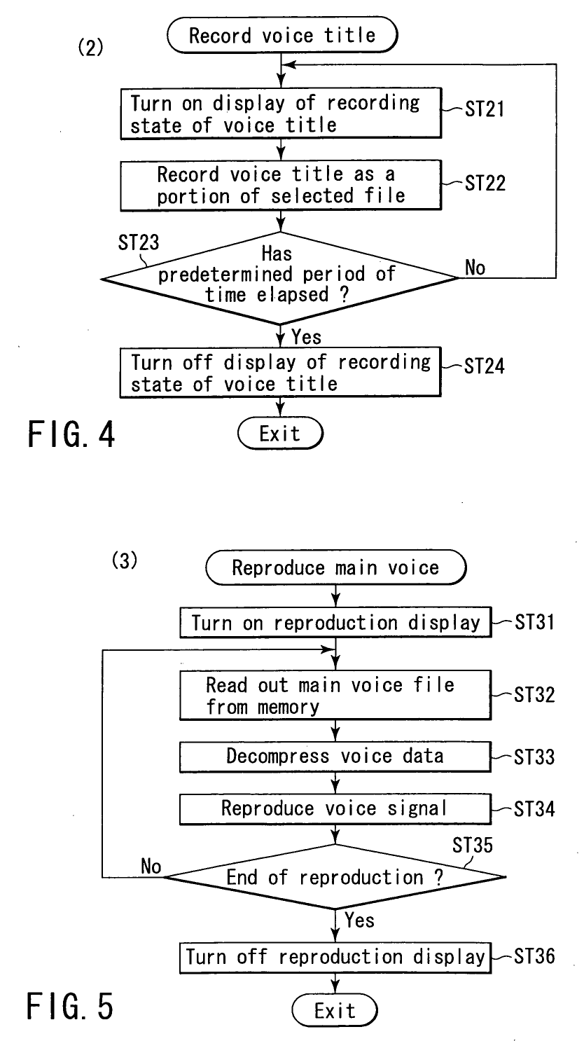

FIG. 4 is a flow chart showing an operation for recording a voice title. The display portion 7 displays the recording state of the voice title. Namely, the display portion 7 displays the record mode display portion 7d, and at the same time, displays the voice title mode display portion 7b in a blinking manner, whereby indicating that recording of the voice title is in progress. Further, the recording integral time display portion 7e displays a voice title recording integral time. In this state, title information according to a voice for explaining the contents of a main voice can be inputted from the microphone 1.

The inputted voice is amplified by the amplifier 2 in the same manner as in main voice recording shown in FIG. 3, and the amplified voice is converted into a digital signal by the A/D converter 3 under the control of the system control portion 5. The converted digital signal is compressed by the digital signal processing portion 4, and the compressed signal is recorded into a terminal portion of a selected main voice data file. Namely, a voice title is recorded into the recording medium 6 as a portion of the selected main voice data file (ST22). In this manner, the main voice and voice title are configured as one file, and can be recorded into the recording medium 6 in a state associated with each other without requiring specific link information.

Recording of the voice title is automatically ended after an elapse of a predetermined period of time under the control of the system control portion 5 (ST23). The system control portion 5 turns OFF the display of the record state of the voice title (the blinking display of the record mode display portion 7d and voice title mode display portion 7b) (ST24). This recording end operation of the voice title may be carried out by pressing the stop button 11c of the operation button portion 11. Alternatively, recording may be carried out while the title record button 11f is pressed, and recording may be ended when the title record button is released. Alternatively, during voice title recording, a display of the recording integral time display portion 7e may be a count down display of the remaining recording time. Further, this voice title recording may be automatically started at the end of main voice recording and may be ended after a predetermined time interval. In that case, there is no need for providing the title record button 11f.

(3) Operation for Reproducing Main Voice

As in step ST03 of FIG. 2, while a file number is searched and displayed, if the reproduction button 11b is pressed as in step ST05 (in the case of YES), the system control portion 5 reproduces a main voice which corresponds to the displayed file number.

FIG. 5 is a flow chart showing an operation for reproducing a main voice. The system control portion 5 displays the reproducing mode display portion 7c (ST31); sequentially reads out record data on a main voice from the recording medium 6 (ST32); and feeds the read-out data to the digital signal processing portion 4. The digital signal processing portion 4 decompresses the compressed record data (ST33). The D/A converter 8 converts the decompressed voice data into an analog voice signal, the voice signal is amplified by the amplifier 9, and the amplified signal is reproduced as a voice from the speaker 10 (ST34). When the stop button 11c is pressed or when main voice reproduction ends (in the case of YES in ST35), the system control portion 5 turns OFF a display of the reproducing mode display portion 7c (ST36).

(4) Operation for Reproducing Voice Title

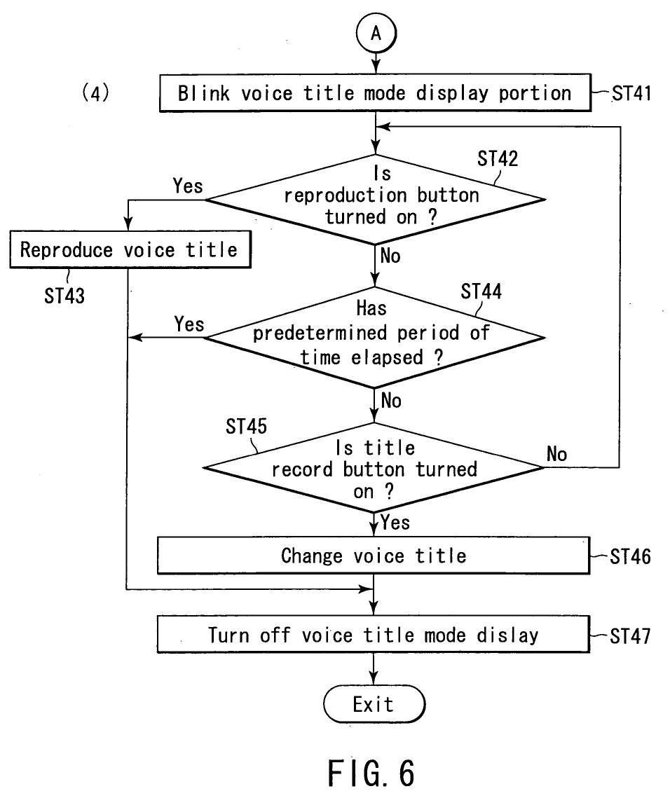

In step ST06 of FIG. 2, the system control portion 5 determines whether or not the voice title is recorded to be associated with the main voice selected in accordance with steps ST02 and ST03. In the case where the voice title is recorded to be associated with the main voice (in the case of YES in ST06), the flow goes to step ST41 of FIG. 6. In step ST41, the system control portion 5 displays the voice title mode display portion 7b in a blinking manner for a predetermined period of time, and indicates that the voice title exists. During this blinking display, if the reproduction button 11b of the operation button portion 11 is pressed (YES in ST42), the system control portion 5 reproduces the voice title while it displays the voice title mode display portion 7b in a blinking manner (ST43).

Reproduction of this voice title is carried out in the same manner as main voice reproduction of FIG. 5. That is, the system control portion 5 displays the reproduction display portion 7c, and at the same time, this control portion displays the voice title mode display portion 7b in a blinking manner, whereby indicating that voice title reproduction is in progress, and reads out the voice title associated with the selected main voice from the recording medium 6. The read-out voice title is decompressed by the digital signal processing portion 4, and the decompressed voice title is converted into an analog signal by the D/A converter 8. The converted analog signal is amplified by the amplifier 9, and the amplified analog signal is reproduced as a voice from the speaker 10. By this voice title reproduction, the recorded contents of the selected main voice can be easily recognized.

As shown in FIG. 1, the title reproduction button 11g is provided at the operation button portion 11, whereby the voice title associated with the selected main voice may be configured to be reproduced according to a press of this title reproduction button 11g.

(5) Operation for Changing Voice Title

As in step ST31 of FIG. 6, while the title voice mode display portion 7b is displayed in a blinking manner, if the title record button 11f is pressed as in step ST35 (in the case of YES), the recorded voice title can be changed as in step ST36.

This title change is made in the same manner as voice title recording of FIG. 4 after data on the existing voice title has been erased. That is, the system control portion 5 displays the recording mode display portion 7d, and at the same time, this control portion displays the voice title mode display portion 7b in a blinking manner, whereby indicating that voice title recording is in progress. Then, a voice signal newly inputted from the microphone 1 is recorded as a voice title into the recording medium 6. This voice title is recorded as a portion of file of the selected file number.

As has been described above, additional information such as a title or memo associated with the recorded contents can be recorded and reproduced as voice information, not as character information, thereby making it easy to search a recorded file.

Further, information such as a title or memo is provided as voice information instead of character information. Thus, a voice input function and a voice output function which are essentially possessed as basic functions by the voice recording and reproducing apparatus can be utilized. In addition, a circuit or device to be added to input and output additional information can be minimized. As a result, a small sized, light weight apparatus can be provided.

In the case where the recorded contents are searched, in search based on character information, there is a need for visually reading information, and thus, a display portion of the apparatus must be kept track of. However, in a search based on voice information, if operation of the apparatus is learned, there is no need for keeping track of the display portion of the apparatus. In search of the recorded contents as well, it becomes possible to pay attention to another matter, and it becomes possible to search the recorded contents while doing another work.

Conventionally, in the voice recording and reproducing apparatus in which a plurality of main voice information have been recorded, there has been a need for reproducing each main voice in order to know the contents of the recorded main voice information. However, according to the present embodiment, voice information indicating the contents of main voice information is recorded as additional voice information associated with a main voice. By reproducing this information, even if the main voice is not reproduced, it is possible to check whether or not the content or target main voice exists. Therefore, target main voice information can be easily searched from among a plurality of main voice information.

Character information can be used as additional information associated with main voice information. However, in the case where character information is used, an input portion such as a keyboard is required as input means for recording such character information. In addition, in the case where a small sized portable apparatus is constructed, there is a need for selectively inputting many characters by switches such as a small number of buttons, and the operation becomes very complicated. On the other hand, in the case where additional voice information according to the present embodiment has been used, as described above, a voice input portion essentially possessed as a basic function by the voice recording and reproducing apparatus can be used as an input portion. As constituent elements to be added to the voice recording and reproducing apparatus in order to record additional information, it is sufficient to provide only the operating switch 11f for triggering the start of recording additional voice information in one embodiment or the switch 11f and only the operating switch 11g for triggering the start of reproducing additional voice information. Therefore, in the case where a portable voice recording and reproducing apparatus is constructed as well, a small sized, light weight apparatus can be provided, and it becomes possible to prevent higher cost due to addition of constituent elements.

Now, a data structure of the above-described file will be described here.

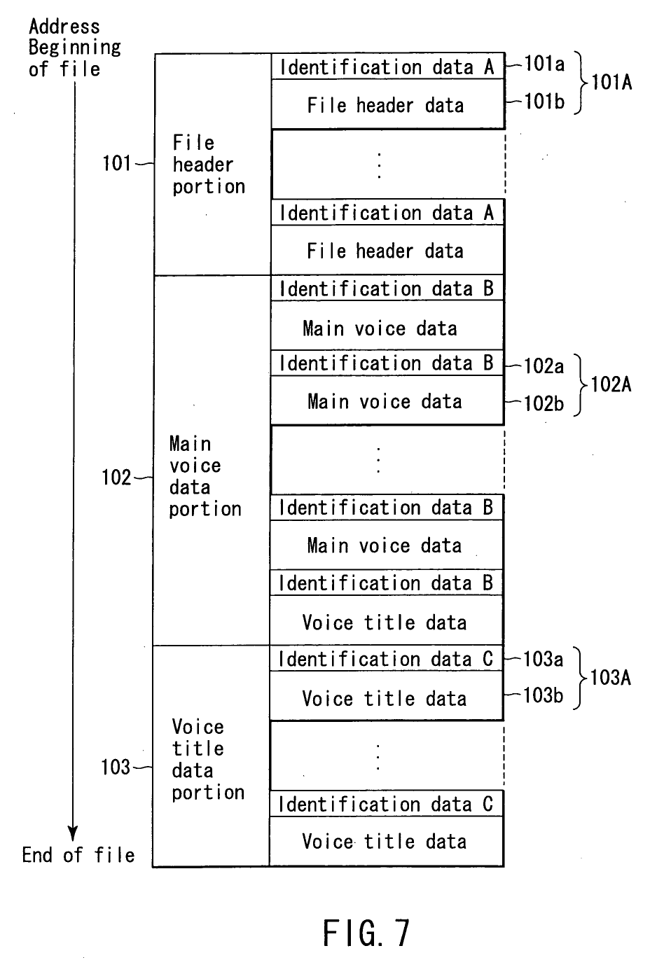

FIG. 7 shows a structure of recording one file containing record data on a main voice and a voice title, namely, one item.

Recording of one item is composed of a file header portion 101 at a file beginning portion; a subsequent main voice data portion 102; and a voice title data portion 103. Each portion is configured as a set of packets 101A, 102A, and 103A of a predetermined size. Further, in each packet, at a beginning portion, identification data of a predetermined size for identifying type of the packet is allocated as packet headers 101a, 101a, and 103a, and subsequently, data 111b, 102b, and 103b of the packets are allocated. For example, data indicating that identification data A of 101a is a packet header of a header portion is stored, and a plurality of identification data A are all the same.

Additional information other than voice such as index information, belonging to that file, is recorded into the file header data 101b of the file header portion 101. This index information indicates book mark information or the like useful to make a search for a file. Main voice data is recorded as main voice data 102b into each packet of the main voice data portion 102.

The voice title data portion 103 has a structure identical to the main voice data portion 102 in a region for recording a voice title associated with a main voice. The recorded main voice data 102b and voice title data 103b are provided as data compressed in the same voice compression format.

Further, a file in which no voice title associated with a main voice is recorded does not have the voice title data portion 103, and one file is composed of only the file header portion 101 and the main voice data portion 102.

Main voice record data and voice title record data associated therewith are recorded into the recording medium 6 as follows.

When a main voice is first recorded, identification data A (101a) first produces the file header portion 101 added at the beginning of packets. In a region following the file header portion 101, identification data B sequentially records the packet 102A of main voice data added at the beginning of packets. After the last packet of the main voice data portion 102 has been written, when recording of main voice data is ended, file header data 101b of the first file header portion 101 is updated as required, and one record is ended.

Then, in the case where a voice title associated with a main voice of this file is added, packs 103A of voice title data obtained by adding identification data C at the beginning of packets are sequentially recorded in the form added at the end portion of the main voice data portion 102.

The start address and end address of each file (or start address and data length of the file) are recorded as a FAT (file allocation table) 6a into the recording medium 6 by the system control portion 5. In the recording medium 6, when one file is divided into a plurality of regions, the start address and end address of each region (or start address and data length of the region) are recorded as a file recording place in the FAT. For example, following the main voice data portion 102 of file number “n”, after a file of a next file number (n+1) has been recorded, in the case where a voice title data portion 103 of file number “n” is recorded, the start address and last address of the voice title data portion 103 (or start address and data length of the data portion) are recorded into the FAT 6a. The start address is referred to as a jump destination address of a file of file number “n”. Namely, the addresses indicating the reproduction sequence of files each are stored in the FAT 6a.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A voice recording and reproducing apparatus, comprising:
a first voice recording portion which records an input voice as a main voice into a recording medium;
a second voice recording portion which inputs a voice associated with the main voice recorded into the recording medium, and records the voice as additional voice information into the recording medium to be associated with the main voice;
a selector portion which selects the main voice recorded into the recording medium;
an additional voice reproducing portion which reproduces the additional voice information to be associated with the main voice selected by the selector portion; and
a main voice reproducing portion which reproduces the main voice selected by the selector portion.

2. A voice recording and reproducing apparatus according to claim 1, further comprising:
an voice information recording portion including an A/D converter which converts an analog voice signal into a digital signal, a compressing portion which compresses the digital signal, and a write portion which writes the compressed digital signal into the recording medium,
the first and second voice recording portions compressing the inputted voice in the same compression scheme, and recording the compressed voice into the recording medium by using the voice information recording portion.

3. A voice recording and reproducing apparatus according to claim 1, further comprising an operating portion to input a user's instruction, the operating portion comprising: as operation buttons,
a record button and a reproduction button for the main voice;
an additional voice information record button for indicating recording start of the additional voice information; and
an additional voice information reproduction button for indicating reproduction start of the additional voice information.

4. A voice recording and reproducing apparatus according to claim 1, wherein a recording time of the additional voice information is set at a predetermined period of time, and the second voice recording portion stops recording of the additional voice information if the predetermined period of time has elapsed after starting recording of the additional voice information.

5. A voice recording and reproducing apparatus according to claim 1, wherein the second voice recording portion displays a recording integral time in a countdown manner until the predetermined period of time has elapsed from recording start of the additional voice information.

6. A voice recording and reproducing apparatus according to claim 1, wherein, in the case where additional voice information associated with the selected main voice information is already recorded in the recording medium, the selector portion displays that the additional voice information is in the recording medium.

7. A voice recording and reproducing apparatus according to claim 1, wherein, in the case where additional voice information associated with the selected main voice information is already recorded in the recording medium, the selector portion displays that the additional voice information is in the recording medium, and the additional voice reproducing portion reproduces the additional voice information.

8. A voice recording and reproducing apparatus according to claim 1, further comprising an operating portion to input a user's instruction, the operating portion having a reproduction button for reproducing the main voice as an operation button,
in the case where additional voice information associated with the selected main voice information is already recorded in the recording medium, the selector portion blinks a display portion which indicates that the additional voice information is in the recording medium for a predetermined period of time, and the second voice recording portion starts reproduction of the additional voice information in response to a press of the reproduction button during the blinking display.

9. A voice recording and reproducing apparatus according to claim 1, wherein the second voice recording portion, after the main voice has been recorded by the first voice recording portion, starts recording of additional voice information associated with the main voice, and stops recording of the additional voice information after elapse of a predetermined period of time.

10. An additional voice information recording method, comprising:
recording an inputted voice as a main voice into a recording medium;
inputting a voice associated with the main voice recorded into the recorded medium; and
recording the voice associated with the main voice as additional voice information into the recording medium to be associated with the main voice.
